(19) United States
(12) Patent Application Publication
(10) Pub. No.: US 2002/0060520 A1
(43) Pub. Date: May 23, 2002

(54) Metal-made seamless pipe and process for production thereof

(76) Inventor: Norikazu Niimi, Nagoya (JP)

Correspondence Address: BURR & BROWN, PO BOX 7068, SYRACUSE, NY, 13261-7068, US

(21) Appl. No.: 09/957,261

(22) Filed: Sep. 20, 2001

(30) Foreign Application Priority Data
Oct. 3, 2000 (JP) PCT/JP00/06876
Jul. 18, 2001 (JP) 2001-217592

(51) Int. Cl. H01J 17/18; B22F 3/20

(52) U.S. Cl. 313/623; 148/421; 148/423; 419/41

(57) ABSTRACT

A metal-made seamless pipe contains, as a main component, at least one kind of metal selected from the group consisting of metals each having a melting point of 1,600° C. or more. The metal-made seamless pipe has a porosity of 0.3 to 25% when the porosity is defined as a proportion of the open pores not perforating in the thickness direction of the pipe, present at the outer surface of the pipe, to the total area (100%) of the outer surface of the pipe; and a process for producing such a metal-made seamless pipe. The metal-made seamless pipe is low in processability but can be produced in a small thickness and a small inner diameter, is superior in mechanical strengths and gastightness, and can be suitably used as a sealing member of a translucent vessel of a high-pressure discharge lamp.

### BACKGROUND OF THE INVENTION AND RELATED ART STATEMENT

The present invention relates to a metal-made seamless pipe and a process for producing such a pipe. More particularly, the present invention relates to a metal-made seamless pipe which is low in processability but can be produced in a small thickness and a small inner diameter, which is superior in mechanical strengths and gastightness, and which can be suitably used, for example, as a sealing member of a translucent vessel (e.g. a ceramic-made translucent vessel) of, for example, a high-pressure discharge lamp (e.g. a metal halide lamp); as well as to a process for producing such a metal-made seamless pipe.

As shown in FIG. 5, a translucent ceramic pipe 20 (a translucent pipe) is used as a translucent vessel of a high-pressure discharge lamp 10 (e.g. a metal halide lamp), because the translucent vessel contains a light emitting material (e.g. dysprosium iodide) of high corrosivity and accordingly requires corrosion resistance.

In order to seal the translucent ceramic pipe 20 (a translucent pipe) used as a translucent vessel, a metal-made pipe 30 (e.g. a Mo pipe) was proposed as a sealing member (European Patent Publication EP 0982278A1).

The metal (e.g. Mo or W) used in such a metal-made pipe, however, is generally low in processability and there has been a limit in producing the pipe in a small thickness and a small inner diameter.

Since the metal is low in processability and its cutting is difficult, production of a metal-made pipe therefrom has been conducted ordinarily by sintering a metal ingot and subjecting the sintered metal ingot to rolling, drawing or the like to obtain a pipe-shaped material.

In such a production process, it has been extremely difficult to obtain a metal-made pipe of small thickness and small diameter.

In view of the above-mentioned problems, the object of the present invention is to provide a metal-made seamless pipe which is low in processability but can be produced in a small thickness and a small inner diameter, which is superior in mechanical strengths and gastightness, and which can be suitably used, for example, as a sealing member of a translucent vessel (e.g. a ceramic-made translucent vessel) of, for example, a high-pressure discharge lamp (e.g. a metal halide lamp); and a process for producing such a metal-made seamless pipe.

### SUMMARY OF THE INVENTION

In order to achieve the above object, the present invention provides a metal-made seamless pipe and a process for production thereof, both shown below.

[1] A metal-made seamless pipe containing, as a main component, at least one kind of metal selected from the group consisting of metals each having a melting point of 1,600° C. or more, which pipe has a porosity of 0.3 to 25% when the porosity is defined as an areal proportion of the open pores not perforating in the thickness direction of the pipe, present at the outer surface of the pipe, to the total area (100%) of the outer surface of the pipe.

[2] A metal-made seamless pipe according to the above [1], wherein the metals each having a melting point of 1,600° C. or more are Mo, W, Re, Ti, Hf and Zr.

[3] A metal-made seamless pipe according to the above [1], wherein the melting point of each metal is 2,600° C. or more.

[4] A metal-made seamless pipe according to the above [3], wherein the metals each having a melting point of 2,600° C. or more are Mo, W and Re.

[5] A metal-made seamless pipe according to any of the above [1] to [4], which has an inner diameter of 0.4 to 3.0 mm and a thickness of 0.05 to 1.0 mm.

[6] A metal-made seamless pipe according to any of the above [1] to [5], which further contains, in addition to the metal, at least one kind of oxide selected from the group consisting of Al₂O₃, Y₂O₃, Dy₂O₃, Gd₂O₃, Ho₂O₃ and Tm₂O₃, in an amount of 0.02 to 5% by volume relative to 100% of the total of the metal and the oxide.

[7] A process for producing a metal-made seamless pipe, which comprises:

preparing a mixture containing (1) 80 to 98% by weight of a powder of at least one kind of metal selected from the group consisting of metals each having a melting point of 1,600° C. or more and (2) a binder in a solvent,

kneading the mixture for 0 to 3 hours and then extruding the kneaded material to form a pipe-shaped material, and

drying the pipe-shaped material at −5 to 25° C. for 10 hours (shortest) to 48 hours (longest) from the completion of the extrusion and thereafter at 30 to 120° C. for 0.5 to 8 hours and then firing the dried material at a lower temperature selected from a temperature between 1,000 to 2,100° C. and a temperature lower by 300° C. than the melting point of the metal.

[8] A process for producing a metal-made seamless pipe according to the above [7], wherein the metals each having a melting point of 1,600° C. or more are Mo, W, Re, Ti, Hf and Zr.

[9] A process for producing a metal-made seamless pipe according to the above [7], wherein the melting point of each metal is 2,600° C. or more.

[10] A process for producing a metal-made seamless pipe according to the above [9], wherein the metals each having a melting point of 2,600° C. or more are Mo, W and Re.

[11] A process for producing a metal-made seamless pipe according to any of the above [7] to [10], wherein the metal-made seamless pipe obtained after firing of the pipe-shaped material at a lower temperature selected from a temperature between 1,000 to 2,100° C. and a temperature lower by 300° C. than the melting point of the metal, has an inner diameter of 0.4 to 3.0 mm and a thickness of 0.05 to 1.0 mm.

[12] A process for producing a metal-made seamless pipe according to any of the above [7] to [11], wherein in preparation of the mixture, there is further added, in addition to the components used, at least one kind of oxide selected from the group consisting of Al₂O₃, Y₂O₃, Dy₂O₃, Gd₂O₃, Ho₂O₃ and Tm₂O₃, in an amount of 0.02 to 5% by volume relative to 100% of the total of the metal and the oxide.

[13] A process for producing a metal-made seamless pipe according to any of the above [7] to [12], wherein the drying of the pipe-shaped material is conducted in an atmosphere containing the vapor of the solvent.

### BRIEF DESCRIPTION OF THE DRAWINGS

FIG. 1 is a graph showing a relation of porosity and gastightness in metal-made seamless pipe.

FIG. 2 is a sectional view schematically showing a peeling test which comprises peeling a thin W plate attached to an alumina plate via an Al₂O₃—Y₂O₃—Dy₂O₃—La₂O₃ type ceramic composition, from the alumina plate at a given force.

FIG. 3 is a graph showing the gastightnesses when Mo, W, Re, Ti, Hf and Zr were used and their porosities were all fixed at 5%..

FIG. 4 is a graph showing a relation of thickness, inner diameter and gastightness in metal-made seamless pipe.

FIG. 5 is a sectional view schematically showing a state in which a metal-made seamless pipe is used as a sealing member for the ceramic-made translucent vessel of a high-pressure discharge lamp (e.g. a metal halide lamp).

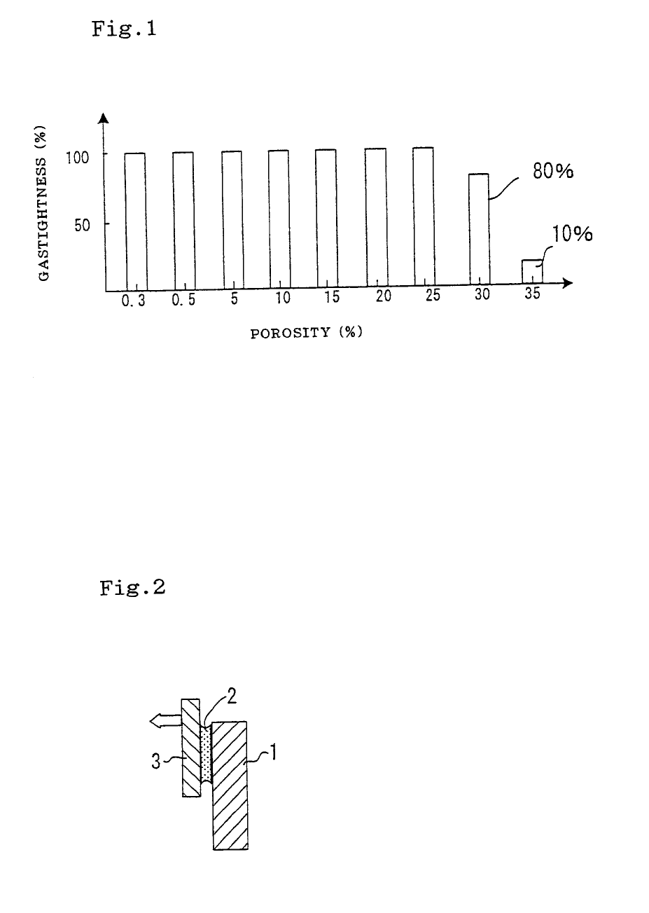

### DETAILED DESCRIPTION OF PREFERRED EMBODIMENTS

The preferred embodiments of the metal-made seamless pipe and the process for production thereof, both of the present invention are specifically described below with reference to the accompanying drawings.

The metal-made seamless pipe of the present invention contains, as a main component, at least one kind of metal selected from the group consisting of metals each having a melting point of 1,600° C. or more, and has a porosity of 0.3 to 25% when the porosity is defined as an areal proportion of the open pores not perforating in the thickness direction of the pipe, present at the outer surface of the pipe, to the total area (100%) of the outer surface of the pipe.

The metal-made seamless pipe of the present invention has higher reliability to leak-free (breakage) than pipes having seams, because it has no seam. When a metal-made pipe having a seam is used as a sealing member for translucent vessel of high-pressure discharge lamp (e.g. metal halide lamp), leakage (breakage) tends to occur therefrom because the translucent vessel inside becomes several atm. during the operation of the tube, resulting in lower reliability than in the case of seamless pipe.

As to the kind of the metal having a melting point of 1,600° C. or more, used in the present invention, there is no particular restriction. As preferable examples of the metal, there can be mentioned at least one kind of metal selected from Mo (melting point: 2,623° C.), W (melting point: 3,422° C.), Re (melting point: 3,186° C.), Ti (melting point: 1,668° C.), Hf (melting point: 2,233° C.) and Zr (melting point: 1,855° C.), all having corrosion resistance to the substance sealed into translucent vessel.

Incidentally, Mo and W have a body-centered cubic crystal structure, have a high melting point as mentioned above, and have a very high Vickers hardness of 200 to 450. Re, Ti, Hf and Zr have a close-packed cubic crystal structure, have a high melting point, and are low in crystal slip. Therefore, these metals are very low in processability.

In the present invention, “open pores other than through-pores” refer to pipe-surface pores not perforating (not causing leakage) in the thickness direction of pipe. Such open pores can be confirmed by conducting a He leakage test and making an image analysis for outer surface porosity.

As shown in Table 1, when the porosity of metal-made seamless pipe exceeds 25%, its gastightness is low.

Herein, “gastightness” is measured by fitting a metal-made pipe of 1 mm in outer diameter, 0.7 mm in inner diameter (therefore, 0.3 mm in thickness) and 100 mm in length to a He detector. When the pipe sample number is 10 and all the samples are gastight, the gastightness of the pipe is taken as 100%. “Gastight” refers to that in the He leakage test, the leakage rate is 1.0×10⁻¹⁰ atm.cc/sec or less.

The lower limit of the outer surface porosity is determined by the wettability toward other substance, particularly, cement, ceramic, glass or the like. A lower limit smaller than 0.3% is not preferred as is clear from the results of the following peeling test.

Peeling test

As shown in FIG. 2, a thin W plate 3 was attached to an alumina plate 1 via an Al₂O₃—Y₂O₃—Dy₂O₃—La₂O₃ type ceramic composition; the thin W plate 3 was peeled from the alumina plate 1; the sites of breakage and the evaluations are shown in Table 1.

TABLE 1

| | | Site of breakage | Evaluation |
|---|---|---|---|
| Porosity of | 0.1 | Thin W plate surface | x |
| thin W | | No breakage of ceramic | |
| plate (%) | 0.2 | Thin W plate surface | x |
| | | No breakage of ceramic | |
| | 0.3-0.5 | Thin W plate surface | Δ |
| | | Ceramic on W plate: small | |
| | 1.0 | Ceramic on W plate: | Δ-∘ |
| | | small to medium | |
| | 3.0 | Ceramic on W plate: medium | ∘ |
| | 5.0 | Ceramic on W plate: large | ∘ |

As is clear from Table 1, the presence of ceramic on W plate (the remaining of ceramic composition on the surface side of thin W plate contacting with ceramic composition when the thin W plate was peeled) indicates high wettability, i.e. high adhesivity between thin W plate and ceramic composition. Therefore, a large amount of ceramic on W plate was rated as ◯. No ceramic on W plate was rated as X, and the intermediate between them was rated as Δ. It is appreciated form Table 1 that a porosity of less than 0.3% gives low adhesivity.

When a metal of relatively low melting point is used, sintering takes place at an early timing and proceeds before the binder gas is released; pores generate inside in a large amount and easily become through-pores; as a result, gastightness tends to be low before a porosity of 25% (the upper limit of specified range) is reached.

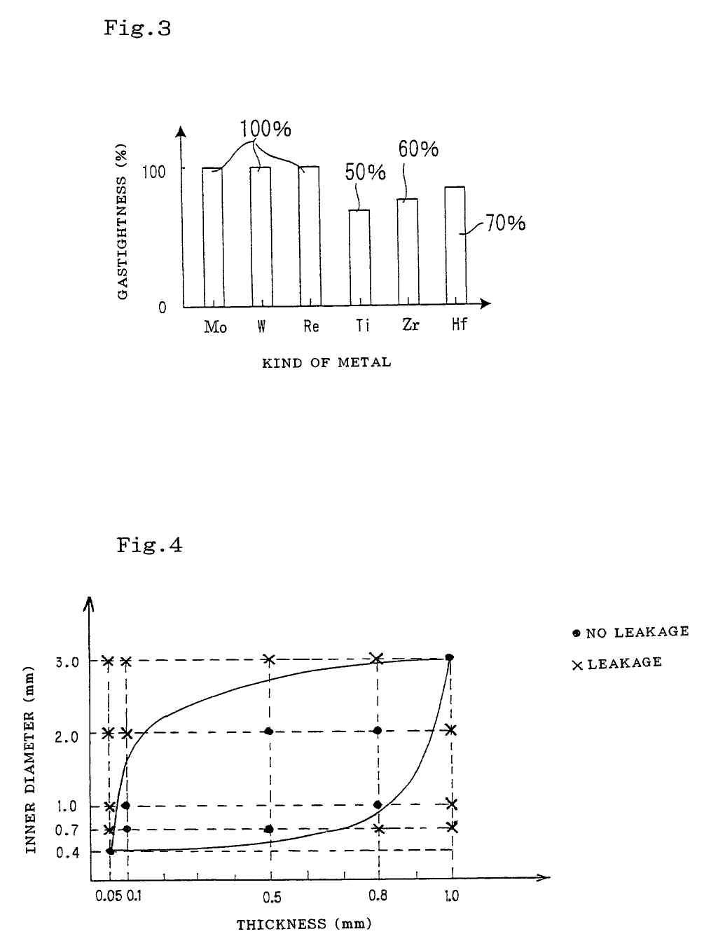

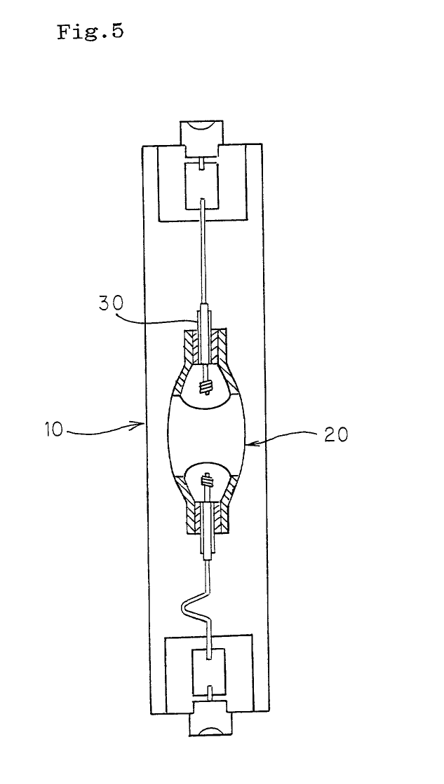

Gastightnesses when Mo, W, Re, Ti, Hf and Zr are used, are compared by fixing the porosity at 5% for all cases. As shown in FIG. 3, of these metals, preferred are metals having a melting point of 2,600° C. or more, i.e. Mo (melting point=2,623° C.), W (melting point=3,422° C.) and Re (melting point=3,186).

The metal-made seamless pipe of the present invention preferably has an inner diameter of 0.4 to 3.0 mm and a thickness of 0.05 to 1.0 mm.

As shown in FIG. 4, no leakage occurs (therefore, superior gastightness is obtained) in a certain region wherein the inner diameter and the thickness are in the above ranges.

For example, when the inner diameter is 3 mm and the thickness is 0.05 mm, the inner diameter is too large and no sufficient increase in density takes place during molding; thus, leakage occurs when the thickness is as small as 0.05 mm.

When the inner diameter is 0.4 mm and the thickness is 1.0 mm, the thickness is too large and non-uniformity in drying speed arises after molding; as a result, drying cracks (microcracks) appear and leakage is incurred.

Preferably, the metal-made seamless pipe of the present invention further contains, in addition to the metal, at least one kind of oxide selected from the group consisting of Al₂O₃, Y₂O₃, Dy₂O₃, Gd₂O₃, Ho₂O₃ and Tm₂O₃, in an amount of 0.02 to 5% by volume, preferably 0.05 to 2% by volume relative to 100% of the total of the metal and the oxide, for improvement in strength. When the amount of the oxide is less than 0.02% by volume, the effect of strength improvement is low. When the amount of the oxide is more than 5% by volume, adverse effects such as reduction in gastightness, brittleness and the like may appear. Of the above oxides, Al₂O₃ is preferred for the corrosion resistance.

The process for producing a metal-made seamless pipe according to the present invention comprises preparing a mixture containing (1) 80 to 98% by weight of a powder of at least one kind of metal selected from the group consisting of metals each having a melting point of 1,600° C. or more and (2) a binder in a solvent; kneading the mixture for 0 to 3 hours, preferably 1 to 2 hours and then extruding the kneaded material to form a pipe-shaped material; drying the pipe-shaped material at −5 to 25° C. (preferably −2 to 15° C.) for 10 hours (shortest) to 48 hours (preferably 24 hours) (longest) from the completion of the extrusion and thereafter at 30 to 120° C., preferably 80 to 100° C. for 0 to 8 hours, preferably 0.5 to 4 hours; then, firing the dried material at a lower temperature selected from a temperature between 1,000 to 2,100° C. and a temperature lower by 300° C. than the melting point of the metal.

Thus, in the present process for producing a metal-made seamless pipe, mild drying is conducted for a given length of time from the completion of the extrusion. This mild drying is necessary to remove the extrusion strain, etc. remaining right after the extrusion (at the start of drying). In drying of, in particular, a pipe-shaped material, the drying speed is inevitably higher than that of a solid (non-hollow) material and, therefore, its drying right after extrusion need be mild. Residual extrusion stress becomes a main cause for firing deformation, etc.

As to the preparation of the mixture, there is no particular restriction. In this step, when the content of the metal powder is less than 80% by weight, drying cracks may appear; when the content of the metal powder is more than 98% by weight, the dispersion of the metal particles may be insufficient.

There is no particular restriction, either, as to the method of kneading and extrusion in the extrusion step.

There is no particular restriction, either, as to the method of drying.

The firing in the firing step is conducted in a non-oxidizing atmosphere or in vacuum. In the firing step, when the firing temperature is lower than a lower temperature selected from 1,000° C. and a temperature lower by 300° C. than the melting point of the metal, insufficient sintering may take place; when the firing temperature is higher than a lower temperature selected from 2,100° C. and a temperature lower by 300° C. than the melting point of the metal, firing deformation may take place depending upon the kind of the metal used.

By employing such a production process, it is possible to easily obtain a thin, small-diameter seamless which has been difficult to obtain with conventional processes; therefore, productivity improvement and consequent cost reduction can be achieved.

The drying of the pipe-shaped material is preferably conducted in an atmosphere containing the vapor of the solvent used in the mixture.

By employing such a production process, mild drying becomes possible and extrusion strain can be reduced.

The present invention is specifically described below by way of Examples. However, the present invention is in no way restricted by these Examples.

### EXAMPLE 1

To 1,000 g of a powder of W (melting point=3,422° C. were added 12 g of ethyl cellulose (a binder), 30 g of butylcarbitol acetate (a solvent) and 10 g of additives including Al₂O₃. The mixture was passed through a tri-roll mill ten times.

The mixture was molded by an extruder. The extrudate was dried in the air at 80° C. for 2 hours.

The dried material was fired in hydrogen at 1,900° C. for 3 hours. To remove the binder while preventing the oxidation of Mo, moistening was made to obtain a dew point of 0° C.

By the above treatment, there was produced a Mo pipe having a porosity of 8% and a leakage rate of 1.0×10⁻¹⁰ atm. cc/sec or less in the He leakage test.

As described above, the present invention can provide a metal-made seamless pipe which is low in processability but can be produced in a small thickness and a small inner diameter, which is superior in mechanical strengths and gastightness, and which can be suitably used, for example, as a sealing member of a translucent vessel (e.g. a ceramic-made translucent vessel) of, for example, a high-pressure discharge lamp (e.g. a metal halide lamp); and a process for producing such a metal-made seamless pipe. The metal-made seamless pipe of the present invention can preferably be used suitably particularly as a sealing member of translucent pipe of, for example, high-pressure discharge lamp (e.g. ceramic-made metal halide lamp). The present metal-made seamless pipe can also be used suitably as a metal pipe produced from a metal of low processability and having a small thickness and a small inner diameter, high heat resistance, high mechanical strengths and superior gastightness, for example, a fine pipe of, for example, heat exchangers used in extreme situations such as space, aviation, military and the like.

What is claimed is:

1. A metal-made seamless pipe containing, as a main component, at least one kind of metal selected from the group consisting of metals each having a melting point of 1,600° C. or more, which pipe has a porosity of 0.3 to 25% when the porosity is defined as an areal proportion of the open pores not perforating in the thickness direction of the pipe, present at the outer surface of the pipe, to the total area (100%) of the outer surface of the pipe.

2. A metal-made seamless pipe according to claim 1, wherein the metals each having a melting point of 1,600° C. or more are Mo, W, Re, Ti, Hf and Zr.

3. A metal-made seamless pipe according to claim 1, wherein the melting point of each metal is 2,600° C. or more.

4. A metal-made seamless pipe according to claim 3, wherein the metals each having a melting point of 2,600° C. or more are Mo, W and Re.

5. A metal-made seamless pipe according to claim 1, which has an inner diameter of 0.4 to 3.0 mm and a thickness of 0.05 to 1.0 mm.

6. A metal-made seamless pipe according to claim 1, which further contains, in addition to the metal, at least one kind of oxide selected from the group consisting of Al₂O₃, Y₂O₃, Dy₂O₃, Gd₂O₃, Ho₂O₃ and Tm₂O₃, in an amount of 0.02 to 5% by volume relative to 100% of the total of the metal and the oxide.

7. A process for producing a metal-made seamless pipe, which comprises:
preparing a mixture containing (1) 80 to 98% by weight of a powder of at least one kind of metal selected from the group consisting of metals each having a melting point of 1,600° C. or more and (2) a binder in a solvent,
kneading the mixture for 0 to 3 hours and then extruding the kneaded material to form a pipe-shaped material, and
drying the pipe-shaped material at −5 to 25° C. for 10 hours (shortest) to 48 hours (longest) from the completion of the extrusion and thereafter at 30 to 120° C. for 0.5 to 8 hours and then firing the dried material at a lower temperature selected from a temperature between 1,000 to 2,100° C. and a temperature lower by 300° C. than the melting point of the metal.

8. A process for producing a metal-made seamless pipe according to claim 7, wherein the metals each having a melting point of 1,600° C. or more are Mo, W, Re, Ti, Hf and Zr.

9. A process for producing a metal-made seamless pipe according to claim 7, wherein the melting point of each metal is 2,600° C. or more.

10. A process for producing a metal-made seamless pipe according to claim 9, wherein the metals each having a melting point of 2,600° C. or more are Mo, W and Re.

11. A process for producing a metal-made seamless pipe according to claim 7, wherein the metal-made seamless pipe obtained after firing of the pipe-shaped material at a lower temperature selected from a temperature between 1,000 to 2,100° C. and a temperature lower by 300° C. than the melting point of the metal, has an inner diameter of 0.4 to 3.0 mm and a thickness of 0.05 to 1.0 mm.

12. A process for producing a metal-made seamless pipe according to claim 7, wherein in preparation of the mixture, there is further added, in addition to the components used, at least one kind of oxide selected from the group consisting of Al₂O₃, Y₂O₃, Dy₂O₃, Gd₂O₃, Ho₂O₃ and Tm₂O₃, in an amount of 0.02 to 5% by volume relative to 100% of the total of the metal and the oxide.

13. A process for producing a metal-made seamless pipe according to claim 7, wherein the drying of the pipe-shaped material is conducted in an atmosphere containing the vapor of the solvent.
